(19) United States
(12) Patent Application Publication
(10) Pub. No.: US 2025/0276593 A1
(43) Pub. Date: Sep. 4, 2025

(54) CABLE CONNECTION SYSTEM

(71) Applicant: Woertz AG, Muttenz (CH)

(72) Inventors: Tamas Onodi, Thalwil (CH); Beat Tschudin, Reinach (CH); Luca Castronari, Himmelried (CH)

(21) Appl. No.: 19/066,478

(22) Filed: Feb. 28, 2025

(30) Foreign Application Priority Data
Mar. 1, 2024 (EP) 24161022.9

(51) Int. Cl. B60L 53/30; H01R 4/2416; H02G 3/16

(52) U.S. Cl. CPC B60L 53/30; H01R 4/2416; H02G 3/16

(57) ABSTRACT

A cable connection system connects a through-line to a charging station. The system comprises a plurality of cores of a through-line designed as separate round cables guided parallel to one another, a junction housing having a plurality of inlets and outlets for one round cable each of the through-line. The junction housing includes multiple outlets for junction lines, which can be connected to the charging station, as well as multiple connection boxes inserted into the junction housing, which can be connected to the charging station. Each connection box contacts a round cable of the through-line without stripping the insulation via piercing contact elements that are suitable for piercing the insulation of the respective round cable and making contact with its conductor. The connection box further connects each junction line to the corresponding round cable of the through-line.

### FIELD OF THE INVENTION

The invention relates to a cable connection system for connecting a through-line to a charging station.

### BACKGROUND OF THE INVENTION

CH 717763 A2 relates to a branch system which comprises a protective housing with through-openings for passing through a multi-core main cable and at least one branch terminal with an electrical connection element for the uninterrupted connection of one core of the main cable to a junction line. Inside the protective housing, the exposed cores of the main cable are kept apart from each other by a spreading device with at least one non-flammable spacer.

### SUMMARY OF THE INVENTION

A cable connection system for connecting a through-line to a charging station is provided, wherein the cable connection system comprises a plurality of cores of a through-line, which are designed as separate round cables, wherein the round cables of the through-line are guided parallel to one another, a junction housing, wherein the junction housing comprises a plurality of inlets for one round cable each of the through-line, as well as a plurality of outlets for one round cable each of the through-line. The junction housing comprises multiple outlets for junction lines, which can be connected to the charging station via the outlets, as well as multiple connection boxes inserted into the junction housing, which can be connected to the charging station via the outlets. Each connection box contacts a round cable of the through-line without stripping the insulation. piercing contact elements are provided for stripping-free contacting, which are suitable for piercing the insulation of the respective round cable and establishing contact with its conductor. A connection box connects each junction line to the corresponding round cable of the through-line, whereby each junction line within the junction housing is connected to an associated outlet for the junction line.

### GENERAL EXPLANATION, ALSO CONCERNING OPTIONAL EMBODIMENTS OF THE INVENTION

A first aspect of the invention relates to a cable connection system for connecting a through-line to a charging station, e.g., designed as a “wall box.”

In the prior art, it is common practice to supply consumers via flat cables laid along walls as a through-line, with junction lines being led from a flat cable to a consumer. However, when supplying (wall) charging stations (e.g., for electric cars), the through-lines must sometimes tolerate high currents and therefore have line cross-sections of 25 mm² or more.

The cable connection system according to the first aspect of the invention comprises multiple cores of a through-line, which are designed as separate round cables, wherein the round cables of the through-line are guided parallel to one another. The round cables of the through-line can have a constant distance from each other over their entire length.

The individual round cables have a higher flexibility, especially bendability, compared to compact flat cables, for example, so that they can be more easily routed around corners in garages, for example, even with large line cross-sections of at least (over 25 mm²). In addition, the fastening of round cables to walls proves to be easier than that of flat cables, since fewer load-bearing elements have to be provided to support the generally lower weight of individual round cables instead of a compact flat cable.

The parallel routing of the individual round cables effectively prevents short circuits. The length of the through-line, i.e., the individual round cables, can be 50 meters, for example, the length of the through-line can be adapted to the local conditions, e.g., in a garage for connecting the charging station.

The cable connection system comprises a junction housing, wherein the junction housing comprises multiple inlets for each round cable of the through-line, as well as multiple outlets for each round cable of the through-line. The junction housing also includes multiple outlets for junction lines, which can be connected to the charging station via the outlets.

The wall charging station can, for example, be an 11 kW charging station with a nominal current consumption of 16 A at 230 V mains voltage or a 22 kW charging station with a nominal current consumption of 32 A at 230 V mains voltage.

The round cables of the through-line are routed straight and at a constant distance parallel to each other via the inlets and outlets for the round cables through the junction housing.

For example, the outlets for the junction lines are either arranged on the same side of the cuboid-shaped junction housing as the outlets for the round cables. The outlets for the junction lines can also be arranged, for example, transversely to the outlets for the round cables, for example on a side of the junction housing that forms a right angle with the side with the inlets or outlets for the round cables. The outlets for the junction lines can also be designed as sockets for charging station connections, which are arranged, for example, along one side of the junction housing.

The cable connection system comprises multiple connection boxes inserted into the junction housing, which can be connected to the charging station via the outlets, with each connection box contacting a round cable of the through-line without stripping the insulation.

piercing contact elements are provided for stripping-free contacting, which are suitable for piercing the insulation of the respective round cable and establishing contact with its conductor.

The stripping-free contact can be made, for example, via contact blades as piercing contact elements or the like, which are provided in the connection boxes. In general, the diameter of a core conductor of a round cable of the through-line is larger than the diameter of a core conductor of a junction line. Therefore, more contact blades can be provided for contacting the round cable of the through-line than for contacting the junction line.

The connection boxes can be opened along a longitudinal axis of the junction housing, i.e., along the feed-through direction for the round cables of the through-line, for example in order to insert a junction line into the connection box for contacting.

For example, the entire junction housing is designed in such a way that it is water and dust-tightness is of class IP20, IP40, IP58, IP65 or IP68. Seals can be provided for this purpose (further details follow in the description of the specific exemplary embodiments). Preferably, arrangements with built-in seals achieve a water or dust tightness of at least class IP58. The entire connection system can therefore also be used in wet environments. The junction housing is therefore intended to prevent contact between the cable sheath of a round cable of the through-line or a junction line, which has been damaged by the contact, and liquids such as water or the like.

A respective connection box connects each junction line to the corresponding round cable of the through-line, whereby each junction line within the junction housing is connected to an associated outlet for the junction line. For example, if the junction line outlets are arranged transversely to the round cable outlets (see above), the junction lines typically describe a right-angled curve inside the junction box. For example, if the outlets for the junction lines are provided on the same side of the junction housing as the inlets or outlets for the round cables of the through-line, the junction lines run parallel above the round cables of the through-line inside the junction housing.

Optionally, the round cables of the through-line can be kept separated from each other by spacers arranged one behind the other. These spacers can have a profile, wherein a round cable of the through-line rests on a support surface (in the profile) of a spacer in order to guide the cores of the through-line parallel to each other towards or away from the junction housing. The spacers can be (pre) manufactured from plastic, for example in one piece.

The spacers can be mounted on a wall at regular intervals (for example 2 meters or so), for which two to three screws may be sufficient due to the low weight of the round cables. For example, in the case of a five-core through-line, the spacers have five support surfaces in their profile for the five round cables of the through-line. In general, the support surfaces of a spacer for the round cables can be arranged parallel to each other. The support surfaces can be designed in the form of notches, wherein the notches for receiving the round cables of the through-line can have a diameter of, for example, 35 mm², 50 mm² or 90 mm², wherein the diameter of the round cables is smaller than the diameter of the notches of the spacers for receiving these round cables.

The spacers are, for example, inserted one behind the other in a cable duct in order to guide the round cables of the through-line parallel along the cable duct. In these embodiments, for example, the entire cable duct is mounted on a wall, with one cable duct leading the round cables of the through-line to the junction housing and one cable duct leading the round cables of the through-line away from the junction housing.

The junction housing can be made at least partially of metal or plastic.

The junction housing is provided, for example, to mechanically protect or electromagnetically shield the contact points of the through-line and the junction line, with at least one seal being provided in the junction housing to enable protection against dust and water ingress at least in accordance with class IP58.

If both the cable duct and the junction housing are made of metal, the magnetic fields generated by the current-carrying conductors can be shielded. For this purpose, a metal insert can also be provided in a plastic housing, provided that the junction housing is predominantly made of plastic. Likewise, a metallic protective layer (e.g., vapor-deposited) can be provided on the outside of a junction housing made (mainly) of plastic. The metal film provides mechanical protection for the plastic housing. Possible plastics from which the junction housing can be made (at least partially) include high-density polyethylene (PE-HD), linear low-density polyethylene (PE-LLD) and low-density polyethylene (PE-LD) or the like.

Overall, the junction housing offers mechanical and electromagnetic protection for the junction.

The through-line may, for example, have five individual round cables as cores, wherein preferably three of the round cables of the through-line are provided as phase conductors, and wherein five corresponding junction lines are connected to associated round cables of the through-line via the connection boxes inside the junction housing.

The through-line made up of multiple individual round cables, in combination with the connection boxes inside the junction housing, enables quick and easy installation of the junction line. The round cables are contacted by the connection boxes using piercing technology without stripping and are not separated for contact, but simply tapped into.

The round cables form “current paths” which, in contrast to busbars, consist of flexible conductors and can therefore easily be routed around corners, which further facilitates the installation of a junction line with a wall box.

For example, the five individual round cables of the through-line correspond to three different phase conductors, and the remaining two round cables of the through-line correspond to a protective conductor and a neutral conductor. In addition to these five round cables, there may also be data conductors; wherein the data conductor(s) can also replace one or two phase conductors.

In some embodiments, the round cables of the through-line have a line cross-section in the range of 15 mm² to 150 mm², in particular the line cross-section of the round cables can be 16 mm², 25 mm², 50 mm², 95 mm² or 120 mm², wherein the round cables of the through-line can preferably be flexibly guided around corners of a room.

The cross-section of the junction line can be in the range of 2 mm² to 10 mm², preferably 4 mm². In general, the cross-section of the junction line is significantly smaller than the cross-section of the through-line and is, for example, less than 30% of the cross-section of the through-line.

The connection boxes can be constructed in multiple parts, wherein a round cable of the through-line is guided through a first part of a connection box, while a junction line is firmly connected to a second part of the connection box, preferably a cover part of the connection box, before contact is made between the round cable of the through-line and the junction line.

In such an embodiment, the connection of the junction line to the connection box is, for example, already pre-assembled. The connection box can therefore already be provided/supplied with the junction line firmly clamped/screwed or otherwise firmly connected to the connection box.

Optionally, the junction lines are already pre-installed in the cover of the junction housing by connecting the junction lines to the respective assigned outlets in the cover of the junction housing. In this way, a junction line can already be firmly connected to an outlet for the respective junction line.

In the case of pre-assembly, for example, it is sufficient to insert the round cables of the through-line, which are led through the junction housing, into the connection box designed to be opened, and to operate a connection mechanism in order to already establish the connection between the junction lines and the through-line. This enables a quick and safe establishment of the electrical connection between the through-line and the outlets of the junction box, which in turn can be connected to the charging station.

The connection box may comprise a metallic contact element provided between a round cable of the through-line and a junction line, for example such that the metallic contact element can contact the round cable of the through-line and the junction line simultaneously. The contact element can have piercing contact elements on both sides, such as cutting edges, pins, etc. A first set of piercing contact elements of the contact element is provided, for example, for contacting the round cable of the through-line without stripping the insulation, and a second set of piercing contact elements of the contact element is provided for contacting the junction line without stripping the insulation. For example, more piercing contact elements can be provided in the set of piercing contact elements for contacting the round cable of the through-line than in the set of piercing contact elements for contacting the junction line.

The through-line can be routed through the box via a support surface on the bottom of the connection box. The metallic contact element can be placed in a suspension (e.g., made of plastic) above the round cable of the through-line, but below a receptacle for the junction line (i.e., between the round cable of the through-line and the junction line). For example, by means of a screw terminal that presses the round cable, the contact element and the junction line towards the bottom of the connection box and thus towards the round cable of the through-line inserted there (or any other clamping element), the connection between the junction line and the round cable of the through-line can finally be established.

The connection box can comprise a base part for the passage of the round cable of the through-line, on which the round cable of the through-line rests, a cover part for receiving a junction line, and an insulating insert. In this case, at least one contact blade can extend from the insert in the direction of the round cable of the through-line and at least one contact blade in the direction of the junction line in order to contact the round cable of the through-line without stripping the insulation and to electrically connect it to the junction line, which is also contacted without stripping the insulation, when the cover part is pressed in the direction of the base part.

The connection box can comprise a lever element, wherein the cover part can be pressed towards the base part by means of the lever element. When making contact, the junction line can be inserted into a receptacle between the insulating insert and the cover part with lever element. The junction line can also already be firmly connected to the cover part of the connection box, so that the junction line does not have to be inserted into the connection box before the lever element is operated.

The connection box may have a metallic contact element which contacts the core of the through-line with two or more contact blades, with a terminal bar integrally connected to the contact blades in order to establish electrical contact with a junction line inserted into the connection box. The at least two contact blades can be arranged one behind the other on the terminal bar. The terminal bar can extend to a receptacle for a strand of the junction line in order to electrically connect this strand to the contact blades and thus to the round cable of the through-line. The junction cable strand can be inserted into the connection box receptacle before it is fixed in place, or it can already be fixed in contact with the terminal bar. The receptacle in the connection box can therefore accommodate a cable clamp.

The junction housing may have seals, preferably rubber seals, in the region of the inlets, outlets and junctions.

The junction housing is, for example, constructed in at least two parts, with one part of the junction housing being designed as a cover. In some embodiments, the sealing elements of the first part of the junction housing, e.g. a base part, and sealing elements of the second part of the junction housing, preferably the cover or an intermediate part, together form the seals in the region of the inlets and outlets of the junction housing. When closing the housing, the sealing elements (on the cover side or intermediate part side and base part side) are pressed together by placing and fixing the cover or intermediate part on the junction housing and are pressed onto the round cables entering and exiting the junction housing.

For example, the entire junction housing is designed in such a way that it has water and dust-tightness of class IP20, IP40, IP65 or IP68.

The cable connection system described above for connection to a charging station (“wallbox”) can also be used to supply tunnel fans, tunnel lighting or other applications. Fireproof designs of the junction box are also possible. Protections (e.g., fuses) may be provided between the through-line and the junction lines.

According to a second aspect, a charging station installation for charging a battery of electric vehicles is provided. The charging station installation comprises: a through-line, multiple charging stations for the electric vehicles, multiple cable connection systems arranged along the through-line according to the first aspect described above, each of which electrically connects one of the charging stations to the through-line.

According to a third aspect, an installation kit for a charging station installation for charging the battery of electric vehicles is provided. The installation kit comprises multiple charging stations for charging electric vehicles, a line which is dimensioned in terms of its current load as a through-line for a plurality of charging stations to be connected, and multiple cable connection systems according to the first aspect for contacting the through-line at a plurality of points without stripping the insulation in order to electrically connect the charging stations arranged along the through-line to the through-line.

### BRIEF DESCRIPTION OF THE DRAWING

The drawing serves to illustrate the cable connection system, charging station installation and installation kit described above by means of exemplary embodiments. In particular:

FIG. 1 is a schematic illustration of an example of a junction housing with connections for round cables of a through-line and outlets for the associated junction lines,

FIG. 2 is a schematic illustration of an example of multiple junction housings from FIG. 1, to which the round cables of the through-line are led by means of a cable duct shown as an example and from which the round cables of the through-line are also led away by a cable duct, wherein a charging station for an electric car is connected to each junction housing,

FIG. 3 is a schematic illustration of an example of spacers inserted into the cable duct of FIG. 2 together with the cable duct,

FIG. 4A is a schematic illustration of an example of contacting five round cables of a through-line through a first embodiment of a connection box, wherein the simultaneous contacting of both a round cable of the through-line and an associated junction line takes place via a metallic contact element with two different sets of piercing contact elements, wherein the metallic contact element is arranged between the round cable of the through-line and the junction line,

FIG. 4B shows schematically an example of contacting five round cables of a through-line through a second embodiment of a connection box, wherein the simultaneous contacting of both a round cable of the through-line and an associated junction line takes place via a single contact blade,

FIG. 4C shows schematically an example of a contacting of five round cables of a through-line through a third embodiment of a connection box, wherein a round cable of the through-line is contacted by at least one contact blade, wherein the contact blade is connected to a cable clamp for a junction line,

FIG. 4D shows schematically an example of a junction housing with connection boxes inserted therein according to FIG. 4C, wherein the junction lines are firmly connected on the one hand to outlets for the junction lines in a cover part of the junction housing and on the other hand are firmly coupled to the cable terminal of the respective connection box,

FIG. 5 shows schematically an example of a connection of five round cables of a through-line with associated junction lines made by five connection boxes as shown in FIG. 4A,

FIG. 6 shows schematically an example of a multi-part construction of a junction housing as in FIG. 1, with seals which are inserted into a base part and an intermediate part of the junction housing in order to seal the round cables of the through-line when entering the junction housing and when exiting the junction housing,

FIG. 7 shows schematically a large representation of the second embodiment of a connection box shown in FIG. 4B,

FIG. 8A shows schematically a detailed representation of the third embodiment of a connection box (FIG. 4C) in the closed state,

FIG. 8B shows schematically an example of a terminal bar with two contact blades which is used in the connection box shown in FIG. 8A,

FIG. 8C shows schematically an example of a sectional view of the connection box shown in FIG. 8A in the closed state;

### DESCRIPTION OF EXEMPLARY EMBODIMENTS BASED ON THE DRAWING

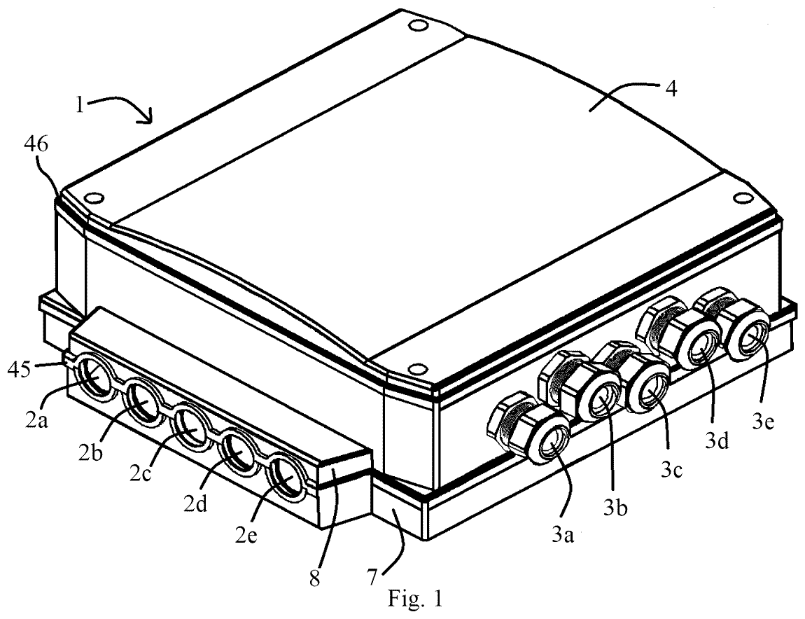

FIG. 1 is a schematic illustration of an example of a junction housing with connections for round cables of a through-line and outlets for associated junction lines.

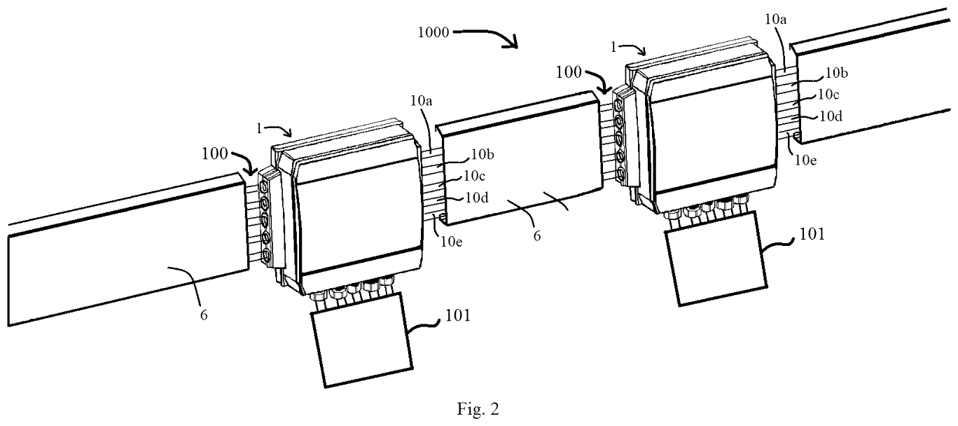

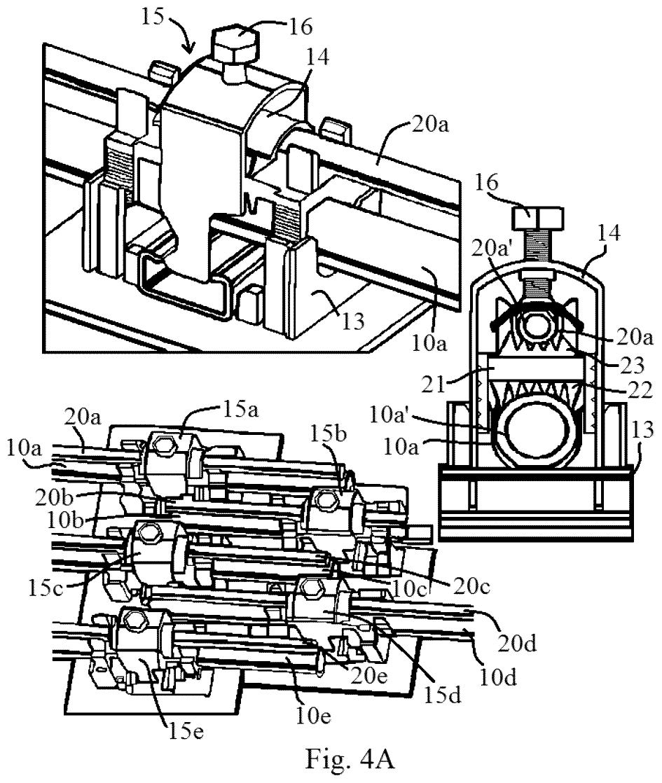

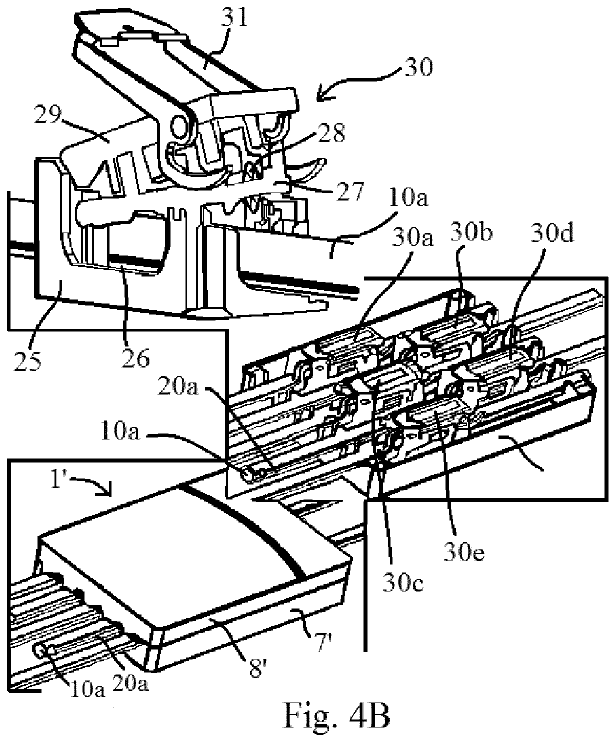

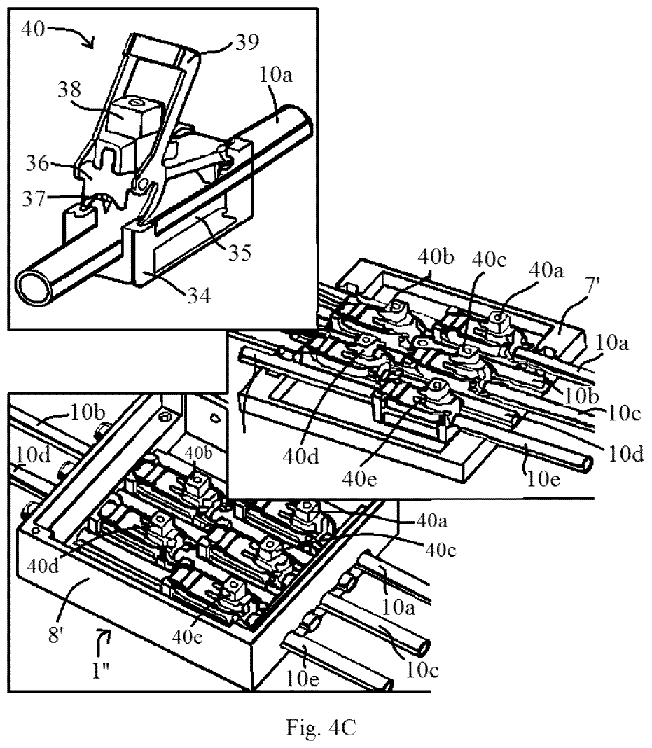

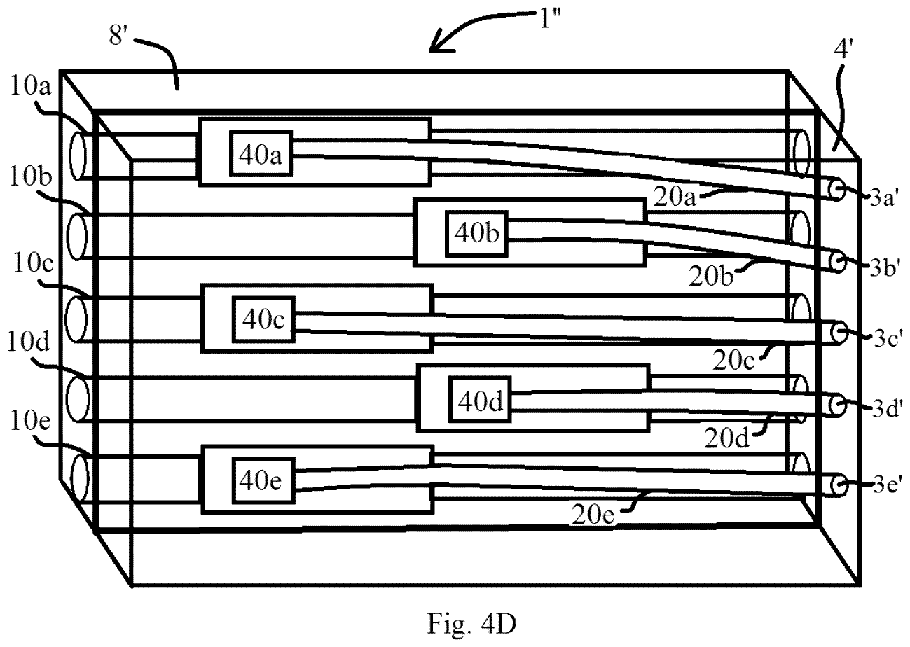

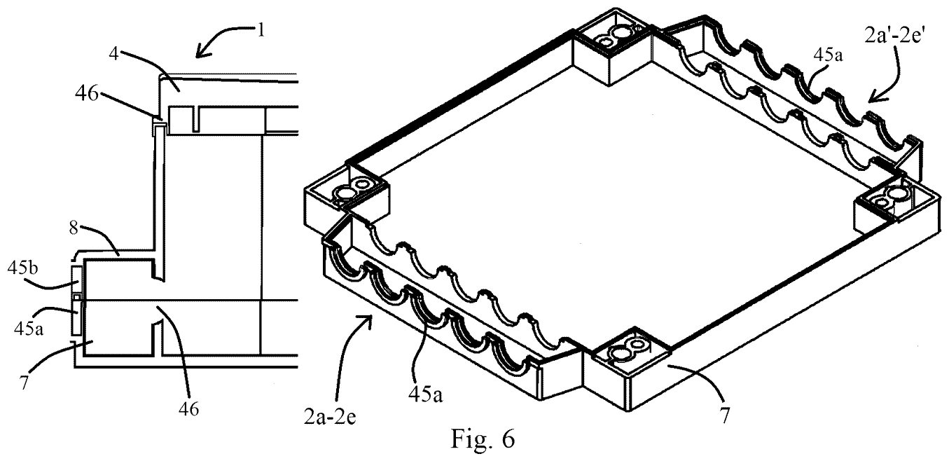

The junction housing 1 according to this exemplary embodiment is constructed in multiple parts: a base part 7 and an intermediate part 8 together enclose inlets 2a to 2e and outlets (see e.g. FIG. 6) for the round cables of the through-line (see e.g. FIG. 2, FIG. 4A to FIG. 4B). The intermediate part 8 is arranged between the base part 7 and a cover part 4 of the junction housing 1. The three parts (base part 7, intermediate part 8, cover part 4) of the junction housing 1 are sealingly connected to one another when the junction housing 1 is closed.

The region of the inlets 2a-2e is provided with a two-part seal 45 around the inlets. The same applies to the outlets not shown in FIG. 1 (see FIG. 6). A seal 46 is also provided at the connection point of the cover part 4 with the intermediate part 8. A cross section of the two-part seal 45 and also of the seal 46 is shown in FIG. 6. The seals 45 and 46 of the junction housing 1 serve to seal the junction housing against liquids and dust when round cables of the through-line are inserted, for example within the scope of class IP20, IP40 or IP65 or IP68.

The junction housing also comprises outlets 3a-3e for the junction lines. In the embodiment according to FIG. 1, these outlets 3a-3e are arranged at right angles to the inlets 2a-2e for the round cables of the through-line. The outlets 3a-3e for the junction lines are located on the intermediate part 8 of the junction housing 1, i.e. they are arranged higher on the junction housing than the inlets 2a-2e for the through-line.

FIG. 2 is a schematic illustration of an example of multiple junction housings from FIG. 1, to which the round cables of the through-line are led by means of a cable duct shown as an example and from which the round cables of the through-line are also led away by a cable duct, with a charging station for an electric car being connected to each junction box.

The cable duct 6 guides the round cables 10a-10e of the through-line 100 to and from the junction housing 1 (see FIG. 1 for details). The round cables 10a-10e are routed parallel to each other and spaced apart from each other along the cable duct 6. This way, short circuits between the round cables can be avoided. The round cables 10a-10c can be designed as phase conductors, while the round cable 10d can be designed as a neutral conductor and the round cable 10e as a protective conductor (PE).

Wall charging stations 101 (“wallbox”) are connected to the two junction boxes 1 shown here only in schematic form.

The through-line 100, the junction housings 1 and the wall charging stations 101 together form the charging station installation 1000.

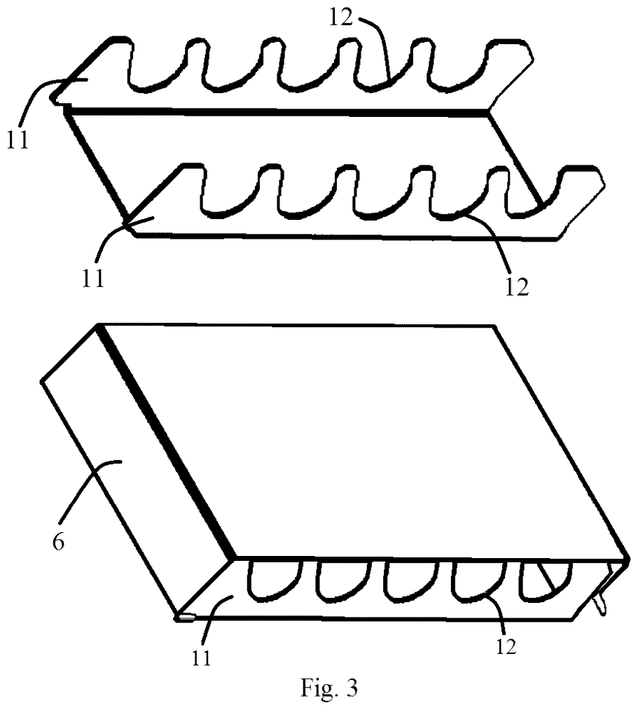

An example of spacers for the round cables inserted into the cable duct of FIG. 2, also in combination with the cable duct, are shown schematically in FIG. 3.

The spacers 11 are, for example, inserted one behind the other at regular intervals (e.g. one meter, two meters, etc.). The spacers 11, which are designed as profile parts made of plastic, have support surfaces (notches) 12 in which the round cables 10a-10e of the through-line (see e.g. FIG. 2, FIG. 4A-4C) rest parallel to one another and are thus guided parallel along the cable duct 6.

The spacers 11 are, as mentioned above, manufactured for example as profile parts made of plastic and can in particular be designed in one piece. The cable duct 6 can be open or closed.

FIG. 4A is a schematic illustration of an example of an arrangement for contacting five round cables of a through-line through a first embodiment of a connection box, wherein the simultaneous contacting of both a round cable of the through-line and an associated junction line takes place via a metallic contact element with two different sets of piercing contact elements, wherein the metallic contact element is arranged between the round cable of the through-line and the junction line.

The example of a connection box 15 shown in FIG. 4A is constructed from at least two insulating bodies (base part 13, cover part 14) which engage with one another (e.g., in a variable position). The connection box 15 serves to connect a round cable 10a with an associated junction line 20a.

The round cable 10a is guided through the base part 13 of the connection box 15 and rests with its underside on this base part 13 or on a support surface of this base part 13. The metallic contact element 21 is arranged on the upper side of the round cable 10a, the lower piercing contact elements 22 (first set of piercing contact elements) of which point in the direction of the upper side of the round cable 10a. The junction line 20a inserted into the cover part 14 rests with its underside on the upper piercing contact elements 23 (second set of piercing contact elements) of the metallic contact element 21. The cover part 14 and the base part 13 are made of plastic, for example.

As can be seen from FIG. 4A, the first set of piercing contact elements (upper piercing contact elements 23) has fewer individual cutting elements or spikes than the second set of piercing contact elements 22 (lower piercing contact elements), since lower currents flow via the junction line 20a than via the round cable of the through-line 10a, since the tapping points on the through-line are designed overall for higher currents and therefore a larger contact area is provided between the metallic contact element 21 and the round cable 10a of the through-line than for the junction line 20a.

A screw terminal arrangement 16, as an example of a terminal arrangement, fixes the junction line 20a inserted into the cover part 14 and can be used to press the junction line 20a in the direction of the metallic contact element 21 and thus in the direction of the round cable 10a inserted into the base part 13.

When pressure is exerted by the screw terminal arrangement in the direction of the base part 13 and the round cable 10a, the upper piercing contact elements 23 of the metallic contact element 21 contact the core conductor 20a′ of the junction line 20a. Thus, the junction line 20a is contacted without stripping the insulation. Likewise, the core conductor 10a′ of the round cable 10a is contacted by the lower piercing contact elements 22 of the metallic contact element 21. This means that the round cable 10a of the through-line is also contacted without stripping the insulation. The metallic contact element 21 thus establishes an electrical connection between the round cable 10a of the through-line and the junction line 10a.

For example, five connection boxes 15a to 15e are inserted (e.g. next to each other) into the junction housing 1 (see e.g. FIG. 1, FIG. 2, FIG. 6) in order to connect five round cables 10a-10e of the through-line 100 (see FIG. 2) with five junction lines 20a-20e while fixing the screw terminal arrangements 16 of the connection boxes 15a to 15e. The connection boxes 15a to 15e are constructed like the connection box 15 shown here.

FIG. 4B shows schematically an example of an arrangement for contacting five round cables of a through-line through a second embodiment of a connection box, wherein the simultaneous contacting of both a round cable of the through-line and an associated junction line takes place via a single contact blade.

The connection box 30 shown as an example in FIG. 4B, for example, has a three-part structure. The round cable 10a of the through-line 100 (see FIG. 2) has a base part 25 with a support surface 26 on which the round cable 10a rests. The round cable 10a is led through the base part 25 and thus through the connection box 30. An insulating insert 27 is inserted into the base part 25 of the connection box 30, from which a contact blade 28 extends both in the direction of the base part 25 or the support surface 26 (i.e. in the direction of the round cable passed through), and in the direction of a cover part 29 of the connection box 30, wherein a junction line 20a can be accommodated between the cover part 29 and the insulating insert 28. The base part 25, the insulating insert 27 and the cover part 29 are made of plastic, for example.

For example, a lever element 31 is mounted on the cover part 29 (or elsewhere on the connection box 30), with which the cover part is pressed in the direction of the base part 25 (or its support surface 26) and thus in the direction of the round cable 10a of the through-line. In this case, both a junction line 20a inserted between the insulating insert 27 and the cover part 29 and the round cable 10a guided through the base part 25 are contacted by the contact blade 28 without stripping the insulation. The (metallic) contact blade 28 thus establishes an electrical connection between the round cable 10a of the through-line and the junction line 10a.

Five connection boxes of this type 30a-30e are provided to connect, for example, five round cables 10a-10e of a through-line with five junction lines 20a-20e and are inserted into a junction housing 1′ for this purpose. As shown in FIG. 4B, in this exemplary embodiment, the junction lines are led out of the junction housing 1′ parallel to the round cables of the through-line. Thus, in this junction housing 1′, unlike in junction housing 1 (see FIG. 1), the outlets for the junction lines are not arranged at right angles to the inlets or outlets for the round cables of the through-line, but on the same side of junction housing 1′, essentially parallel to the inlets or outlets of junction housing 1′.

FIG. 4C shows schematically an example of an arrangement for contacting five round cables of a through-line through a third embodiment of a connection box, wherein a round cable of the through-line is contacted by at least one contact blade, wherein the contact blade is connected to a cable clamp for a junction line.

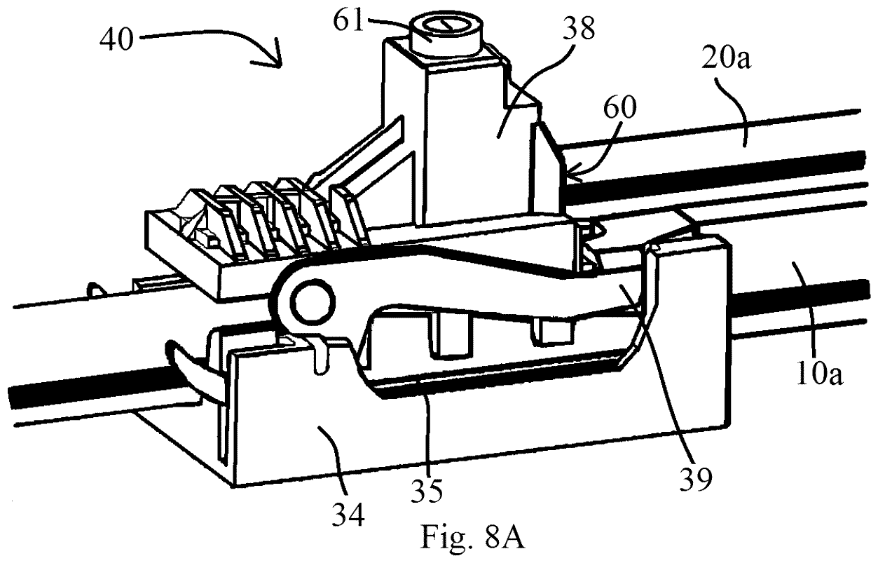

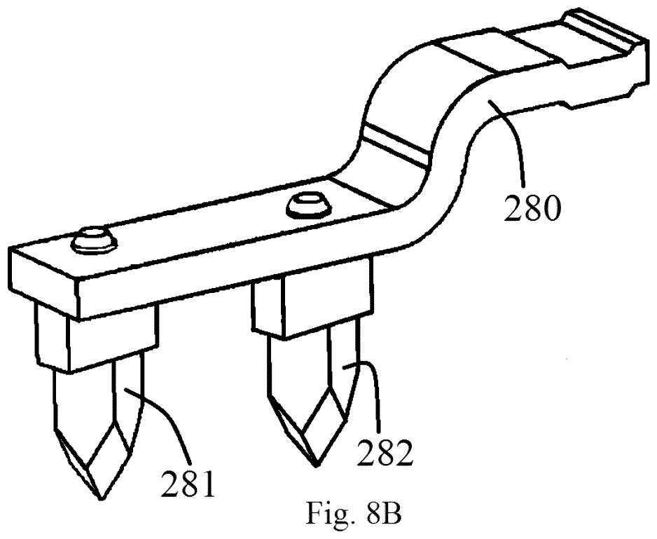

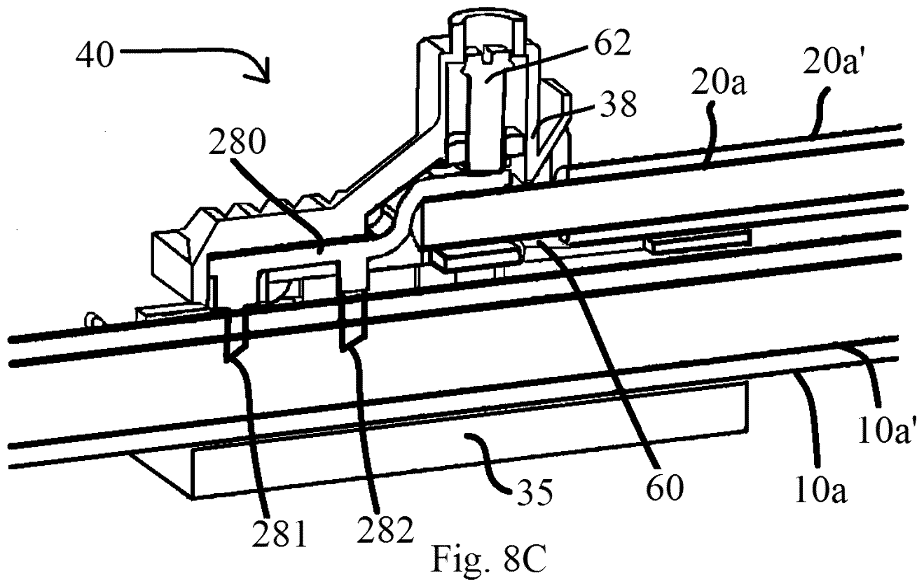

The connection box 40, also shown in more detail in FIG. 8A-C, contacts a round cable 10a of the through-line 100 (see FIG. 2), which rests on a support surface 35 of a base part 34 of the connection box 40 and is guided through the base part 34, by means of a contact blade 37.

The contact blade 37 is inserted into an insulating body 36. The contact blade 37 is connected to a cable clamp 38 into which a core conductor 20a′ (strand) of a junction line 20a can be inserted and fixed there in order to establish an electrical connection with the contact blade 37 and thus with the round cable 10a of the through-line 100 (see FIG. 2). The contact blade 37 can be pressed by means of a lever element 39 in the direction of the base part 34 or its support surface 35 and thus in the direction of the round cable 10a inserted therein in order to contact the round cable 10a without stripping the insulation and to connect it electrically to the cable clamp 38.

Five connection boxes 40a-40e are inserted into a junction housing 1″ to contact five round cables 10a-10e and thus connect them to the cable terminals of the connection boxes 40a-40e. The round cables are routed between a base part 7′ and an intermediate part 8′ of the junction housing 1″, wherein the intermediate part 8′ is placed on the base part 8′ as in FIG. 1.

As shown in FIG. 4D, the junction lines can be fixedly inserted into a cover part of the junction housing 1″ in order to be connected to the cable terminals 28 (see FIG. 4C) of the connection boxes 40a-40e, wherein the junction lines are already fixedly connected to the outlets for the junction lines in the cover part.

In the illustration according to FIG. 4D, the cover part 4′ is already placed on another part of the junction housing 1″, such as the intermediate part 8′. Within the cover part 4″, the junction lines 20a-20e are already firmly connected to the corresponding outlets 3a′-3e′ for the junction lines.

During installation (which has already taken place in the illustration according to FIG. 4D), the individual junction lines 20a-20e must only be fixed in the cable clamps 38 (see e.g. FIG. 8D) with the connection boxes 40a-40e in order to establish the connection with the round cables 10a-10e of the through-line, which are already contacted by the connection boxes 40a-40e (e.g. via a single lever pull per junction box) without stripping.

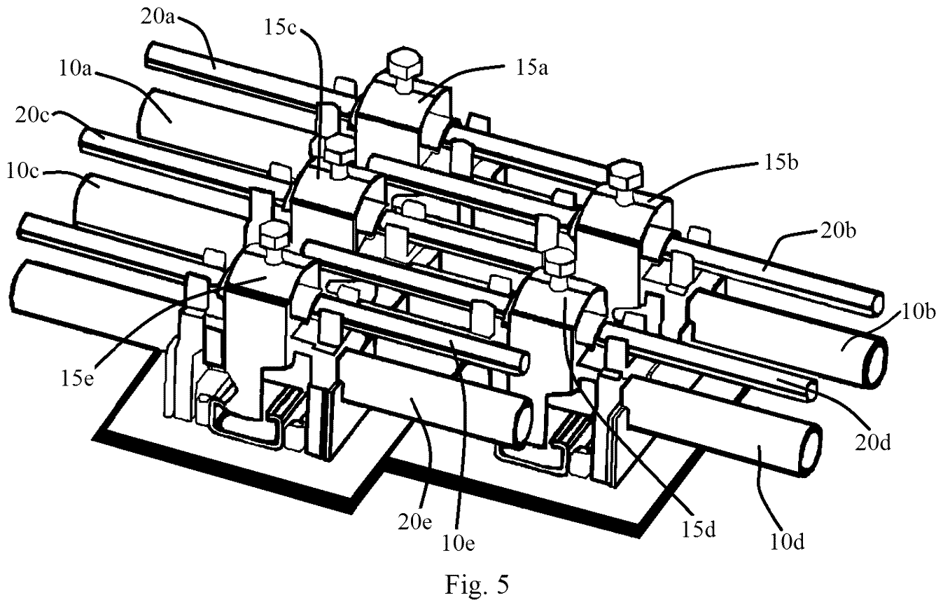

FIG. 5 shows schematically an enlarged illustration of an example of a connection of five round cables of a through-line with associated junction lines made by five connection boxes as shown in FIG. 4A.

The connection boxes 15 (according to the first embodiment) here connect five round cables 10a-10e of a through-line 100 (see FIG. 2) with five associated junction lines 20a-20e. The arrangement shown in FIG. 5 is, for example, inserted into a junction housing 1 (see FIG. 1).

FIG. 6 shows schematically an example of a multi-part construction of a junction housing as in FIG. 1, with seals which are inserted into a base part and an intermediate part of the junction housing in order to sealingly enclose the round cables of the through-line when entering the junction housing and when exiting the junction housing.

As already shown in FIG. 1, the junction housing 1 is constructed in at least three parts: it has a base part 7, an intermediate part 8 and a cover part 4. A two-part seal 45 is inserted into the inlets 2a-2e (see FIG. 1).

This seal comprises sealing elements 45a in the region of the base part and sealing elements 45b in the region of the intermediate part 8, wherein the base part-side sealing elements 45a and the intermediate part-side sealing elements 45b can be joined together when the intermediate part 8 is placed on the base part 7 in order to clamp the round cables of a through-line guided through the inlets 2a-2e and outlets 2a′-2e′ between the respective sealing elements 45a, 45b. The seal 45 and the individual sealing elements 45a, 45b are provided, for example, as rubber seals. Behind the seals, an inlet 46 is provided for the respective round cables into the junction housing 1.

Likewise, in the region of the cover part 4 (also referred to herein as cover), a seal 46 is provided where the cover part 4 is placed on the intermediate part 8. This seal 46 of the cover part 4 can also be designed as a rubber seal or as a labyrinth seal.

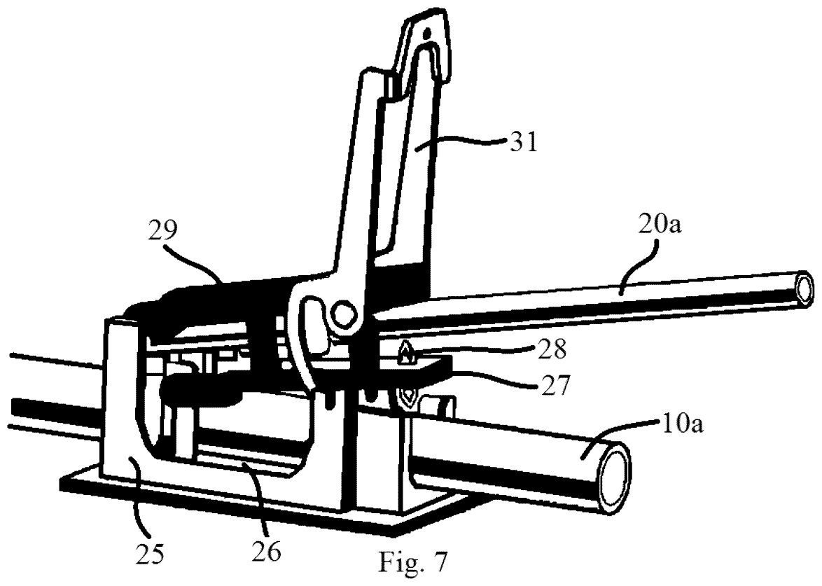

An example of a schematic enlarged view of the second embodiment of a connection box shown in FIG. 4B is shown in FIG. 7.

The connection box 30 shown as an example in FIG. 7, for example, has a three-part structure. The round cable 10a of the through-line 100 (see FIG. 2) has a base part 25 with a support surface 26 on which the round cable 10a rests. The round cable 10a is led through the base part 25 and thus through the connection box 30. An insulating insert 27 is inserted into the base part 25 of the connection box 30, from which a contact blade 28 extends both in the direction of the base part 25 or the support surface 26 (i.e. in the direction of the round cable passed through), and in the direction of a cover part 29 of the connection box 30, wherein a junction line 20a can be accommodated between the cover part 29 and the insulating insert 27.

For example, a lever element 31 is mounted on the cover part 29 (or elsewhere on the connection box 30), with which lever element the cover part is pressed in the direction of the base part 25 (or its support surface). In this case, both a junction line 20a inserted between the insulating insert 27 and the cover part 29 and the round cable 10a guided through the base part 25 are contacted by the contact blade 28 without stripping the insulation. The contact blade 28 thus establishes an electrical connection between the round cable 10a of the through-line and the junction line 20a.

An example of a detailed view of the connection box of FIG. 4C in the closed state is shown in FIG. 8A.

The connection box 40 contacts a round cable 10a of the through-line 100 (see FIG. 2), which rests on a support surface 35 of a base part 34 of the connection box 40 and is guided through the base part 34, by means of a contact blade 37 (see FIG. 4C).

The contact blade 37 (see FIG. 4C) is inserted into an insulating body 36. The contact blade 37 (see FIG. 4C) is connected to a cable clamp 38 into which a core conductor 20a′ (strand) of a junction line 20a can be inserted and fixed there by means of a screw 62 (see FIG. 8C) in the screw channel 61 in order to establish an electrical connection with the contact blade 37 and thus with the round cable 10a of the through-line 100 (see FIG. 2). The contact blade 37 can be pressed by means of a lever element 39 in the direction of the base part 34 or its support surface 35 and thus in the direction of the round cable 10a inserted therein in order to contact the round cable without stripping the insulation and to connect it electrically to the cable clamp 38.

FIG. 8B shows an example of a terminal bar with two contact blades which is used in the connection box shown in FIG. 8A.

A terminal bar 280 holds at its lower end, which is therefore on the through-line side, two contact blades 281, 282, which are inserted one behind the other into the terminal bar 280 in order to extend in the direction of the round cable of the through-line.

FIG. 8C shows a schematic example of a sectional view of the connection box shown in FIG. 8A in the closed state.

As shown in FIG. 8C, the two piercing contact elements (e.g., contact blades, pins, etc.) 281 and 282 contact the round cable 10a of the through-line 100 (see FIG. 2) without stripping the insulation by cutting into its core conductor 10a′. The round cable 10a rests on the support surface 35 of the connection box 40.

When mounting the junction line 10a, the core conductor 20a′ or the strand of the junction line 20a is inserted into a receptacle 60 of the connection box 40 and is fixed there by means of the screw 62 within the cable clamp 38 to the terminal rail 280, which electrically connects the contact blades and thus the round cable 10a of the through-line to the junction line 20a.

1. A cable connection system for connecting a through-line to a charging station, wherein the cable connection system comprises:
multiple cores of the through-line, which are designed as separate round cables, wherein the round cables of the through-line are routed parallel to each other at a constant distance;
a junction housing, wherein the junction housing comprises multiple inlets for each round cable of the through-line, as well as first multiple outlets for each round cable of the through-line,
wherein the junction housing also comprises second multiple outlets for junction lines, which can be connected to the charging station via the second multiple outlets;
multiple connection boxes inserted into the junction housing, which connection boxes can be connected to the charging station via the second multiple outlets,
wherein each connection box contacts one of the round cables of the through-line without stripping an insulation of the one of the round cables;
wherein a first set of piercing contact elements are provided for stripping-free contacting, which are suitable for piercing the insulation of the respective round cable and establishing contact with its conductor,
wherein each connection box connects one of the junction lines to the corresponding round cable of the through-line, whereby each junction line within the junction housing is connected to an associated outlet for the junction line.

2. The cable connection system according to claim 1, wherein the round cables of the through-line are kept separated from one another by spacers arranged one behind the other, wherein each of the round cables of the through-line rests on a respective support surface of one of the spacers in order to guide the cores of the through-line parallel to one another towards the junction housing or away from the junction housing.

3. The cable connection system according to claim 2, wherein the spacers are inserted one behind the other in a spaced manner in a cable duct in order to guide the round cables of the through-line parallel along the cable duct.

4. The cable connection system according to claim 1, wherein the junction housing is at least partially made of metal or plastic, wherein the contact points of the through-line and junction line are mechanically protected or electromagnetically shielded by the junction housing, wherein at least one seal is provided in the junction housing to enable protection against dust and water at least according to class IP58.

5. The cable connection system according to claim 1, wherein the through-line has five individual round cables as cores, wherein preferably three of the round cables of the through-line are provided as phase conductors, and wherein five corresponding junction lines are connected to associated round cables of the through-line.

6. The cable connection system according to claim 1, wherein the round cables of the through-line have a line cross-section in the range of 15 mm2 to 150 mm², in particular wherein the line cross-section of the round cables is 16 mm², 25 mm², 50 mm², 95 mm² or 120 mm², wherein the round cables of the through-line can preferably be guided flexibly around corners of a room.

7. The cable connection system according to claim 1, wherein the connection boxes are constructed in multiple parts, wherein one of the round cables of the through-line is guided through a first part of a connection box, while a junction line is firmly connected to a second part of the connection box, preferably a cover part of the connection box, before contact is made between the round cable of the through-line and the junction line.

8. The cable connection system according to claim 1, wherein the connection box comprises a metallic contact element which is provided between one of the cores of the through-line and one of the junction lines, wherein the first set of piercing contact elements of the contact element are provided for contacting the round cable of the through-line without stripping the insulation and a second set of piercing contact elements of the contact element are provided for contacting the junction line without stripping the insulation.

9. The cable connection system according to claim 1, wherein the connection box comprises a base part for passing through the round cable of the through-line on which the round cable of the through-line rests, a cover part for receiving one of the junction lines, and an insulating insert, wherein at least one of the first set of piercing contact elements extends from the insert in the direction of the round cable of the through-line and at least one contact blade extends in a direction of the junction line in order to contact the round cable of the through-line without stripping the insulation and to electrically connect it to the junction line, which is also contacted without stripping the insulation, when the cover part is pressed in the direction of the base part.

10. The cable connection system according to claim 9, wherein the connection box comprises a lever element, wherein by means of the lever element the cover part can be pressed towards the base part.

11. The cable connection system according to claim 1, wherein the connection box comprises a metallic contact element which contacts one of the cores of the through-line with two or more contact blades, wherein a terminal bar is integrally connected to the contact blades in order to establish electrical contact with one of the junction lines inserted into the connection box.

12. The cable connection system according to claim 1, wherein the junction housing has seals, preferably rubber seals, in the region of the inlets, outlets and junctions.

13. The cable connection system according to claim 1, wherein the junction housing is constructed in at least two parts, wherein a part of the junction housing is designed as a cover.

14. The cable connection system according to claim 13, wherein sealing elements of a first part of the junction housing, preferably a base part, and sealing elements of a second part of the junction housing, preferably the cover or an intermediate part, together form one or more seals in the region of the inlets and the outlets of the junction housing.

15. The cable connection system according to claim 13, wherein the junction lines are already pre-installed in the cover of the junction housing by the junction lines already being connected to the respective associated outlets in the cover of the junction housing.

16. A charging station installation for charging a battery of electric vehicles, comprising:
a through-line,
multiple charging stations for the electric vehicles,
a plurality of cable connection systems according to claims 1 arranged along the through-line, each of which electrically connects one of the charging stations to the through-line.

17. An installation kit for a charging station installation for charging the battery of electric vehicles, comprising:
multiple charging stations for charging electric vehicles;
a line, which is dimensioned in terms of its current load as a through-line for multiple charging stations to be connected; and
multiple cable connection systems according to claim 1 for contacting the through-line at a plurality of points without stripping the insulation in order to electrically connect the charging stations arranged along the through-line to the through-line.
